(19) United States
(12) Patent Application Publication
(10) Pub. No.: US 2025/0069453 A1
(43) Pub. Date: Feb. 27, 2025

(54) HYDRAULIC CLUTCH ACTUATOR FILLING CHECK METHOD AND APPARATUS

(71) Applicants: Hyundai Motor Company, Seoul (KR); Kia Corporation, Seoul (KR)

(72) Inventors: Dong Joo Lee, Seoul (KR); Ho Sung Kim, Seoul (KR); Jeong Heon Kam, Seoul (KR); Hong Suk Suh, Seoul (KR); Sung Hoon Park, Seoul (KR)

(21) Appl. No.: 18/775,066

(22) Filed: Jul. 17, 2024

(30) Foreign Application Priority Data
Aug. 23, 2023 (KR) 10-2023-0110488

(51) Int. Cl. G07C 5/08; F16D 25/06; F16D 25/12; F16D 125/16

(52) U.S. Cl. CPC G07C 5/0825; F16D 25/12; F16D 25/06; F16D 2125/16

(57) ABSTRACT

Provided is a method and apparatus for checking the oil filling of an electronic clutch provided in a vehicle transmission. This approach determines the presence of air inside a hydraulic cylinder or clutch tube based on the current value profile generated when a piston of a hydraulic actuator is driven, without a separate air detection device.

### CROSS-REFERENCE TO THE RELATED APPLICATIONS

This application claims under 35 U.S.C. § 119 (a) the benefit of Korean Patent Application No. 10-2023-0110488, filed on Aug. 23, 2023, which is hereby incorporated by reference as if fully set forth herein.

### BACKGROUND

### Technical Field

The present disclosure relates to a method and apparatus for checking oil filling of an electronic clutch provided in a vehicle transmission.

### Background

Due to recent issues such as high oil prices, electronically controlled manual transmissions, including automated manual transmissions (AMT) and dual-clutch transmissions (DCT), have been increasingly applied to vehicles.

The AMT or DCT may use an actuator to automatically drive a clutch for shifting the gears of a vehicle.

In the case of releasing a vehicle from a vehicle manufacturing factory or replacing a clutch actuator or clutch oil, it is required to discharge air from the hydraulic cylinder or the oil in the clutch tube.

For the clutch actuator, air may not be discharged manually and may thus be discharged by a siphon effect generated as a hydraulic piston moves in a reciprocating and repeated manner by the operation of the actuator.

However, for the hydraulic actuator, there is no method of determining whether air is present inside the hydraulic cylinder, and there may thus be no way to check whether air is present and whether the air is discharged after air bleeding operation that discharges air by moving the hydraulic piston reciprocatively and repeatedly. Therefore, there is a need for a method to solve such an issue.

The foregoing description is provided only for improving the understanding of the background of the present disclosure and should not be considered an acknowledgment that it corresponds to the related art already known to those skilled in the art.

### SUMMARY OF THE PRESENT DISCLOSURE

To solve the technical issues described above, an object of the present disclosure is to provide a clutch actuator filling check method and apparatus that performs a filling check by comparing a current value profile obtained when air is not present during the operation of a clutch actuator and a current value profile obtained when air is present during the operation of the clutch actuator, and performs an air discharging operation through air bleeding when it is determined that air is present.

According to at least one embodiment of the present disclosure, a method of bleeding air trapped in a hydraulic clutch comprises checking a current value profile obtained when a piston in the hydraulic clutch is driven, and performing air bleeding based on a result of the checking the current value profile.

According to at least one embodiment of the present disclosure, the performing air bleeding comprises checking a result value of the checking the current value profile, and performing air bleeding according to the result value.

According to at least one embodiment of the present disclosure, the checking of the result value comprises comparing the current value profile and a normal current value profile obtained under a normal condition, and determining that air is present if a maximum current value in the current value profile is less than a maximum current value in the normal current value profile.

According to at least one embodiment of the present disclosure, the method further comprises re-checking if the air bleeding is complete.

According to at least one embodiment of the present disclosure, checking the current value profile comprises checking a current value profile obtained when an operating stroke of an actuator of the hydraulic clutch is driven.

According to at least one embodiment of the present disclosure, the performing of the air bleeding comprises measuring air bleeding performance time for which the air bleeding is performed, and re-checking if the measured air bleeding performance time meets a predetermined time threshold.

According to at least one embodiment of the present disclosure, the method further comprises checking a re-performance result value obtained after the re-checking the current value profile.

According to at least one embodiment of the present disclosure, the checking of the re-performance result value comprises determining that air is present if a maximum current value in the current value profile is less than a maximum current value under a normal condition.

According to at least one embodiment of the present disclosure, the method may further include displaying a hardware (H/W) inspection request message on a display if a number of times of the re-checking is greater than or equal to a preset number, after the checking of the re-performance result value, and performing air bleeding if the number of times of the re-checking is less than the preset number, and ending the check if it is determined that air is not present, and performing air bleeding if it is determined that air is present.

According to at least one embodiment of the present disclosure, there is provided a non-transitory computer-readable storage medium storing instructions that, when executed by a processor, cause the processor to perform the hydraulic clutch actuator filling check and air bleeding method.

According to at least one embodiment of the present disclosure, an apparatus for bleeding air trapped in a hydraulic clutch comprises a check performing unit configured to check a current value profile obtained when a piston in the hydraulic clutch is driven, air bleeding performing unit configured to perform air bleeding based on a result of the check of the current value profile.

According to at least one embodiment of the present disclosure, the apparatus further comprises a result value checking unit configured to check a performance result value obtained by the checking the current value profile, and wherein the air bleeding performing unit is further configured to perform the air bleeding according to the result value.

According to at least one embodiment of the present disclosure, the air bleeding performing unit is further configured to compare the current value profile and a normal current value profile obtained under a normal condition, and determine that air is present if a maximum current value in the current value profile is less than a maximum current value in the normal current value profile.

According to at least one embodiment of the present disclosure, the check performing unit is further configured to re-check if the air bleeding is complete.

According to at least one embodiment of the present disclosure, the check performing unit is further configured to check a current value profile obtained when an operating stroke of an actuator of the hydraulic clutch is driven.

According to at least one embodiment of the present disclosure, the air bleeding performing unit is further configured to measure air bleeding performance time for which the air bleeding is performed, and if the measured air bleeding performance time meets a predetermined time threshold, re-check the current value profile.

According to at least one embodiment of the present disclosure, the check performing unit is further configured to check a re-performance result value after re-checking.

According to at least one embodiment of the present disclosure, the filling check performing unit is further configured to if it is determined that a maximum current value in the current value profile is less than a maximum current value under a normal condition, determine that air is present.

According to at least one embodiment of the present disclosure, the result value checking unit is further configured to display a hardware (H/W) inspection request message on a display if a number of times of re-checking is greater than or equal to a preset number, and command the air bleeding performing unit to perform the air bleeding if the number of times of re-checking is less than the preset number, wherein the air bleeding performing unit is further configured to end the check if it is determined that air is not present, and perform the air bleeding if it is determined that air is present

According to embodiments of the present disclosure described herein, a filling check for checking whether air is present inside a hydraulic cylinder or clutch tube may be performed based on a current value profile generated when a piston of a hydraulic actuator is driven, without a separate air detection device.

The effects that can be obtained from the present disclosure are not limited to the effects described above, and other effects that are not described above may also be clearly understood by those skilled in the art from the following description.

As discussed, the method and system suitably include use of a controller or processer.

In another embodiment, vehicles are provided that comprise an apparatus as disclosed herein.

### BRIEF DESCRIPTION OF THE DRAWINGS

FIG. 1 is a diagram illustrating a configuration of a hydraulic clutch actuator filling check apparatus according to an embodiment of the present disclosure.

FIG. 2A and FIG. 2B are diagrams illustrating a current value profile and a ramp waveform in a hydraulic clutch actuator filling check apparatus according to an embodiment of the present disclosure.

FIG. 3A is a diagram illustrating a current value profile obtained when a filling check is performed five times by a hydraulic clutch actuator filling check apparatus according to an embodiment of the present disclosure.

FIG. 3B is a diagram illustrating a ramp waveform obtained when a filling check is performed five times by a hydraulic clutch actuator filling check apparatus according to an embodiment of the present disclosure.

FIG. 4 is a diagram illustrating a load value graph based on a clutch load characteristic in a hydraulic clutch actuator filling check apparatus according to an embodiment of the present disclosure.

FIG. 5 is a diagram illustrating a current value profile under a normal condition without air in a hydraulic clutch actuator filling check apparatus according to an embodiment of the present disclosure.

FIG. 6 is a diagram illustrating a current value profile in an abnormal state with air in a hydraulic clutch actuator filling check apparatus according to an embodiment of the present disclosure.

FIG. 7 is a flowchart illustrating a hydraulic clutch actuator filling check method according to an embodiment of the present disclosure.

### DETAILED DESCRIPTION OF THE DISCLOSURE

Hereinafter, embodiments of the present disclosure will be described in detail with reference to the accompanying drawings. The embodiments are not construed as limited to the disclosure and should be understood to include all changes, equivalents, and replacements within the idea and the technical scope of the disclosure.

Although terms including ordinal numbers such as “first,” “second,” and the like may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

In the description of the embodiments, when a layer (or film), region, pattern, or structure is described as formed “above/on” or “below/under” a substrate, layer (or film), region, pattern, or pad, it may be construed that they are in direct contact, or they are in indirect contact with one or more other elements disposed therebetween. In this case, the use of “above/on” or “below/under” may be based on what is shown in the accompanying drawings, and these terms are used only to indicate a relative positional relationship between elements for the convenience of description, but may not be used to limit the actual positions of the elements. For example, “B present (or disposed, positioned, or located) on A” may only indicate that B is shown on or above A in the accompanying drawings, unless otherwise stated or when B needs to be located above A due to the nature of A or B. In an actual product, B may be located under/below A, or B and A may be disposed side-by-side.

In addition, the thickness or size of each layer (film), region, pattern, or structure shown in the accompanying drawings may be changed for clarity and convenience of description, and the actual size is not entirely reflected.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components and a repeated description related thereto is omitted.

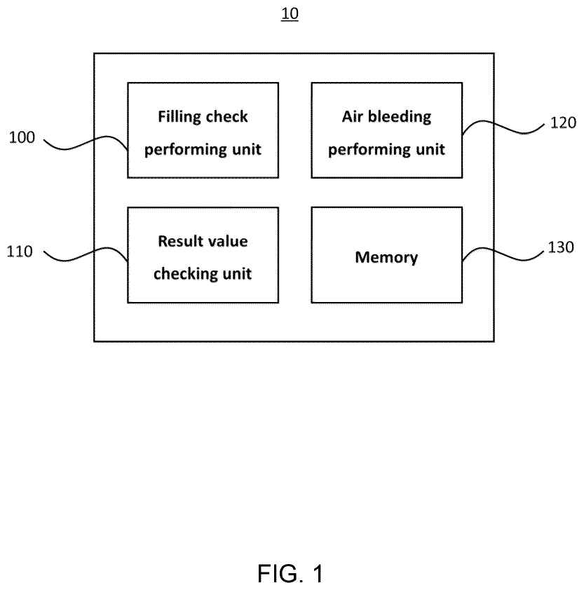

According to at least one embodiment of the present disclosure, referring to FIG. 1, a hydraulic clutch actuator filling check apparatus 10 may include a filling check performing unit 100, a result value checking unit 110, and air bleeding performing unit 120.

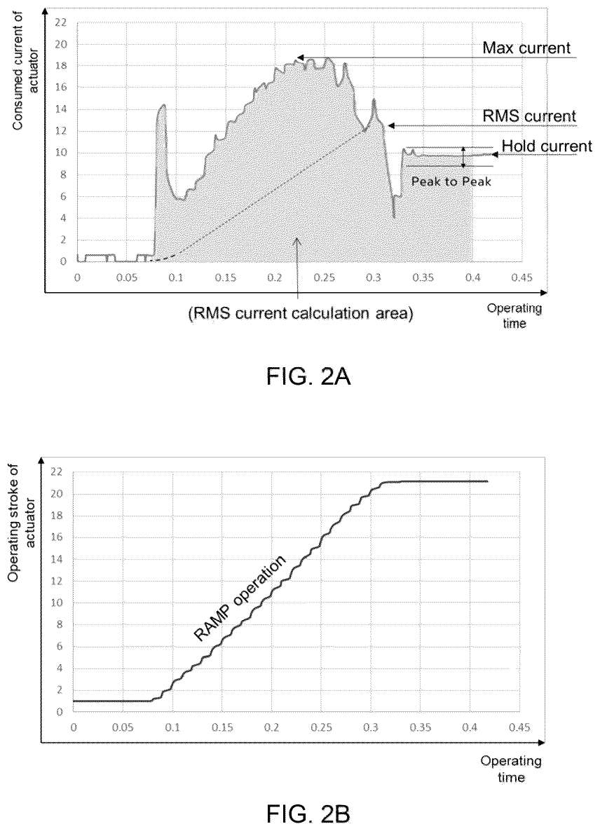

The filling check performing unit 100 may perform a filling check to determine whether air is present in a hydraulic clutch based on a current value profile obtained when a piston is driven up to an operating stroke as shown in FIG. 2A. In this case, a maximum operating stroke refers to a distance that the piston provided inside an actuator moves to its furthest extent due to the pressure within the cylinder.

Specifically, the filling check may be measuring a current value profile as shown in FIG. 2A by moving the actuator to the end of the maximum operating stroke such that a ramp waveform shown in FIG. 2B is generated while the piston is at an operation standby position.

At the filling check, a current value profile under a normal condition may include a maximum (MAX) current, a root mean square (RMS) current, and a hold current (or holding current) measured as shown in FIG. 2A.

The MAX current may be generated at a midpoint of the operating stroke and may be a maximum current value during an operation of the actuator. The RMS current may refer to a root mean square current (e.g., integrated value) during a total time required to reach the maximum operating stroke. The hold current may refer to a current value with a peak-to-peak 0.1 A or less when the piston reaches the end of the operating stroke.

The filling check, carried out by the filling check performing unit 100, may involve repeating a process five times where the piston returns to the operation standby position after waiting for a predetermined period at the end of the maximum operating stroke.

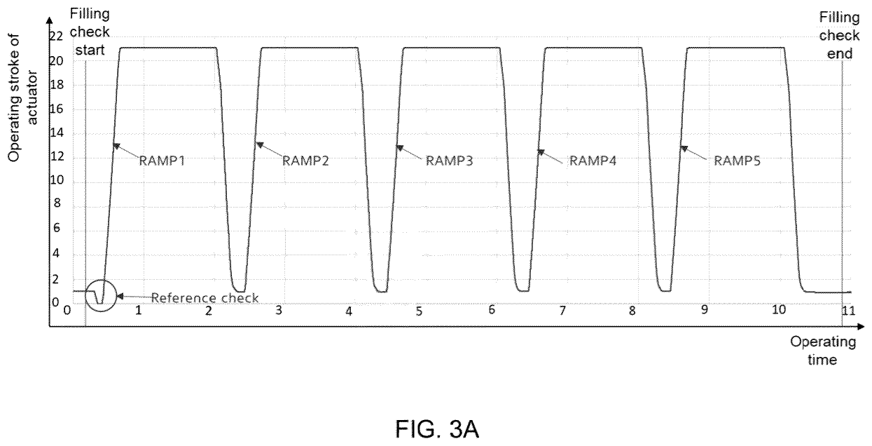

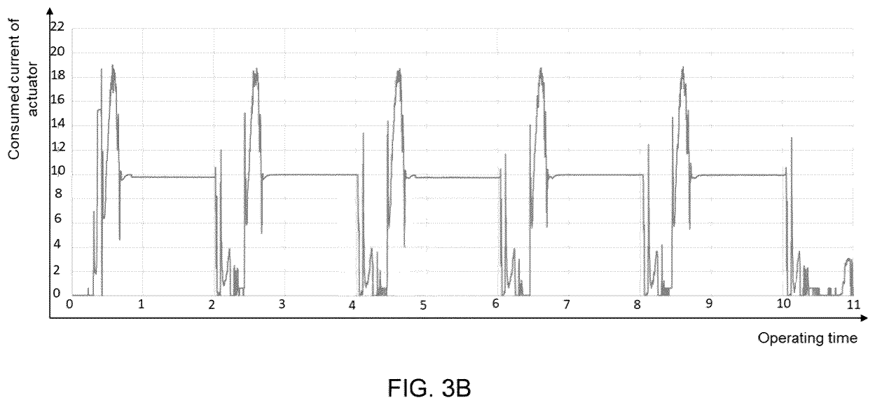

A ramp waveform and a current value profile obtained when the piston reciprocates five times are as shown in FIGS. 3A and 3B.

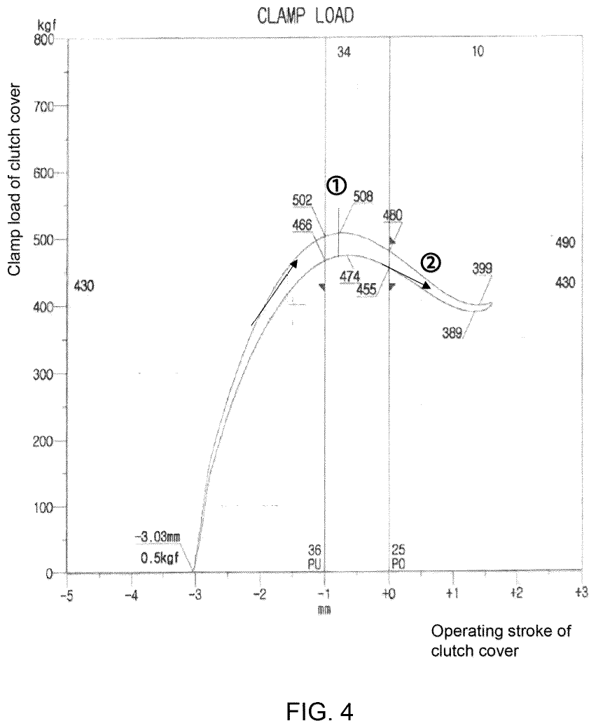

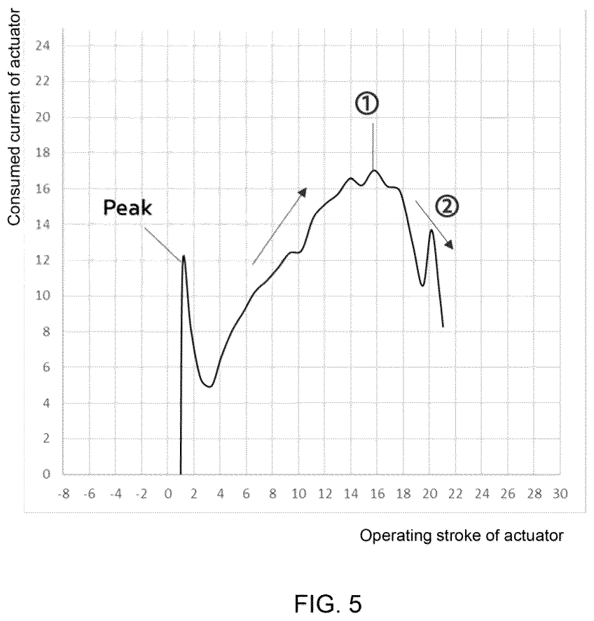

The filling check performing unit 100 may check a current value profile obtained when the hydraulic clutch actuator is driven. A current value may be formed as shown in FIG. 5, and the current value profile may be formed in a similar pattern to that of a value according to a clutch load characteristic as shown in the graph shown in FIG. 4. Specifically, referring to FIG. 4, a pattern in which the load reaches its maximum value at a midpoint \textcircled{1} of an operating stroke of a clutch cover and then decreases toward an endpoint \textcircled{2} of the operating stroke may be shown.

Similarly, a pattern in which a current value according to the operating stroke also reaches its maximum value at the midpoint \textcircled{1} of the operating stroke and then decreases toward the endpoint \textcircled{2} may be shown, and it may thus be possible to check whether air is present through the filling check based on the current value profile.

The filling check performing unit 100 may re-perform the filling check when air bleeding, which will be described below, is complete.

The result value checking unit 110 may check a performance result value obtained from the filling check performing unit 100.

Specifically, the result value checking unit 110 may compare the obtained current value profile and a previously input current value profile in the normal state.

In addition, it may determine that air is present when it is determined that a maximum current value during an operation of the actuator in the current value profile is less than a maximum current value in the normal state.

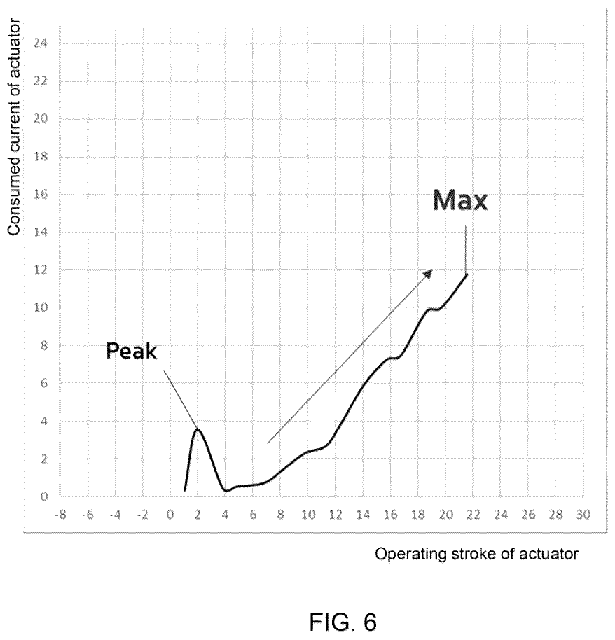

FIG. 5 illustrates a current value profile under a normal condition without residual air, and FIG. 6 illustrates a current value profile in an abnormal state with residual air.

The current value profile measured in the normal state shows a pattern where the maximum current occurs at the midpoint of the operating stroke, and the load gradually decreases as it approaches the maximum point of the stroke.

However, the current value profile obtained in the abnormal state may be measured, showing that a maximum current value does not occur at the midpoint of the operating stroke and the load does not decrease at the maximum point of the operating stroke.

The result value checking unit 110 may determine whether air is present inside a clutch tube based on a difference between these current value profiles. A memory 130 may also be included, and the memory 130 may store the current value profile in the normal state that is input in advance to be used as data for comparing measured current values.

The result value checking unit 110 may check a re-performance result value obtained when the filling check performing unit 100 re-performs the filling check.

The result value checking unit 110 may display a hardware (H/W) inspection request message on a cluster when the number of times of re-performing the filling check is greater than or equal to a set number of times.

It may command the air bleeding performing unit 120, which will be described below, to perform air bleeding when the number of times of re-performing the filling check is less than the set number of times.

When it is determined that air is not present based on the performance result value, the air bleeding performing unit 120 may end the filling check.

Conversely, when it is determined that air is present based on the performance result value, the air bleeding performing unit 120 may perform air bleeding.

The air bleeding performing unit 120 may measure air bleeding performance time for which air bleeding is performed.

Air bleeding may refer to a process in which air is discharged as air moves to a reservoir tank by a siphon effect, which occurs as the piston of the hydraulic cylinder moves reciprocatively and repeatedly.

The air bleeding performing unit 120 may re-perform the filling check when the measured air bleeding performance time is greater than or equal to a set time.

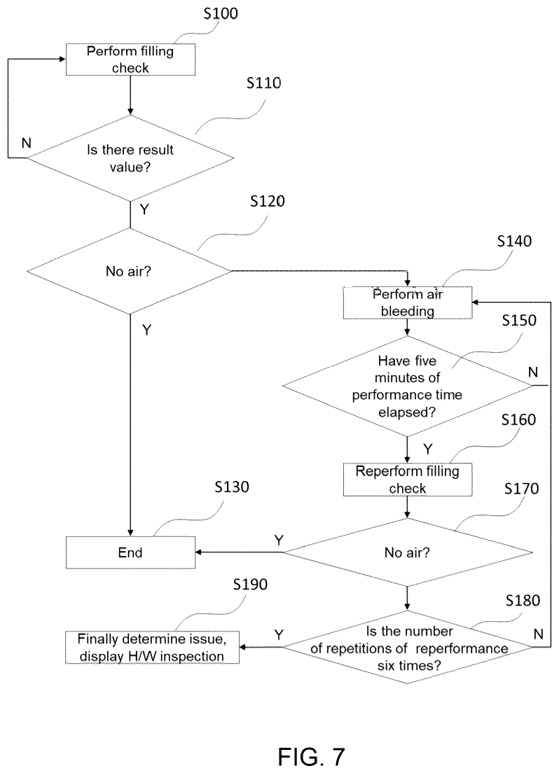

Hereinafter, a hydraulic clutch actuator filling check and air bleeding method according to at least one embodiment of the present disclosure will be described with reference to FIG. 7.

In step S100, the hydraulic clutch actuator filling check and air bleeding method may first perform a filling check to determine whether air is present in a hydraulic clutch based on a current value profile obtained when a piston is driven.

In step S110, the method may check whether there is a performance result value obtained by performing the filling check.

When there is no performance result value obtained by performing the filling check or there is an error, the method may perform the filling check again.

In step S120, when it is determined that the performance result value obtained by performing the filling check is present, the method may check the performance result value.

The checking of the performance result value may be performed through a comparison between the measured current value profile and a current value profile under a normal condition previously stored in the memory 130.

In step S130, the method may end the filling check when it is determined that air is not present based on the performance result value.

In step S140, the method may perform air bleeding when it is determined that air is present based on the performance result value.

In step S150, when the air bleeding is complete, the method may check whether air bleeding performance time has passed a set time. The set time may be approximately five minutes, for example.

In step S160, when the air bleeding performance time has not passed five minutes, the method may continue to perform the air bleeding.

In step S170, when the air bleeding performance time has passed five minutes, the method may re-perform the filling check to determine whether air is discharged.

In step S130, when it is determined that air is not present, the method may end the filling check.

In step S180, when it is determined that air is present, the method may check whether the number of times of re-performing the filling check is greater than or equal to a set number of times. The set number of times may be six times, for example.

In step S190, when it is determined that the number of times of re-performing the filling check is greater than or equal to six times, the method may determine that discharging air may not be easy using the air bleeding or there may be a hydraulic oil leakage issue, and output a clutch inspection sign onto the cluster.

The method according to embodiments of the present disclosure may be embodied as a computer-executable program and stored in a computer-readable storage medium.

Examples of the computer-readable storage medium include a read-only memory (ROM), a random-access memory (RAM), a CD-ROM, a magnetic tape, a floppy disk, an optical data storage device, and the like.

The computer-readable storage medium may be distributed in a computer system connected over a network such that computer-readable code is stored and executed in a distributed manner.

In addition, functional programs, codes, and code segments for implementing the method described above may be easily inferred by programmers in the technical field to which the embodiments of the present disclosure pertain.

While the present disclosure has been described with various embodiments, it will be apparent after an understanding of the disclosure that various modifications and changes in form and details may be made without departing from the spirit and scope of the claims and their equivalents. Therefore, in addition to the foregoing description, the scope of the disclosure may also be defined by the claims and their equivalents, and all variations within the scope of the claims and their equivalents are to be construed as being included in the disclosure.

What is claimed is:

1. A method of bleeding air trapped in a hydraulic clutch, the method comprising:
checking a current value profile obtained when a piston in the hydraulic clutch is driven; and
performing air bleeding based on a result of the checking the current value profile.

2. The method of claim 1, wherein the performing air bleeding comprises checking a result value of the checking the current value profile, and performing air bleeding according to the result value.

3. The method of claim 2, wherein the checking the result value comprises comparing the current value profile and a normal current value profile obtained under a normal condition, and determining that air is present if a maximum current value in the current value profile is less than a maximum current value in the normal current value profile.

4. The method of claim 1, further comprising re-checking if the air bleeding is complete.

5. The method of claim 1, wherein the checking the current value profile comprises checking a current value profile obtained when an operating stroke of an actuator of the hydraulic clutch is driven.

6. The method of claim 1, wherein the performing air bleeding comprises:
measuring air bleeding performance time for which the air bleeding is performed; and
re-checking the current value profile if the measured air bleeding performance time meets a predetermined time threshold.

7. The method of claim 6, further comprising:
checking a re-performance result value obtained after the re-checking the current value profile.

8. The method of claim 7, wherein the checking the re-performance result value comprises:
determining that air is present if a maximum current value in the current value profile is less than a maximum current value under a normal condition.

9. The check method of claim 7, further comprising:
displaying a hardware (H/W) inspection request message on a display if a number of times of the re-checking is greater than or equal to a preset number, after the checking the re-performance result value, and performing air bleeding if the number of times of the re-checking is less than the preset number; and
ending the checking the re-performance result value if it is determined that air is not present, and performing air bleeding if it is determined that air is present.

10. A non-transitory computer-readable storage medium storing instructions that, when executed by a processor, cause the processor to perform the method of claim 1.

11. An apparatus for bleeding air trapped in a hydraulic clutch, the apparatus comprising:
a check performing unit configured to check a current value profile obtained when a piston in the hydraulic clutch is driven;
air bleeding performing unit configured to perform air bleeding based on a result of the checking the current value profile.

12. The apparatus of claim 11, further comprising a result value checking unit configured to check a performance result value obtained by the checking the current value profile, and
wherein the air bleeding performing unit is further configured to perform the air bleeding according to the result value.

13. The apparatus of claim 12, wherein the air bleeding performing unit is further configured to compare the current value profile and a normal current value profile obtained under a normal condition, and determine that air is present if a maximum current value in the current value profile is less than a maximum current value in the normal current value profile.

14. The apparatus of claim 11, wherein the check performing unit is further configured to re-check if the air bleeding is complete.

15. The apparatus of claim 11, wherein the check performing unit is further configured to:
check a current value profile obtained when an operating stroke of an actuator of the hydraulic clutch is driven.

16. The apparatus of claim 11, wherein the air bleeding performing unit is further configured to:
measure air bleeding performance time for which the air bleeding is performed; and
if the measured air bleeding performance time meets a predetermined time threshold, re-check the current value profile.

17. The apparatus of claim 16, wherein the check performing unit is further configured to:
check a re-performance result value after re-checking.

18. The apparatus of claim 17, wherein the filling check performing unit is further configured to:
if it is determined that a maximum current value in the current value profile is less than a maximum current value under a normal condition, determine that air is present.

19. The apparatus of claim 12, wherein the result value checking unit is further configured to:
display a hardware (H/W) inspection request message on a display if a number of times of re-checking is greater than or equal to a preset number, and command the air bleeding performing unit to perform the air bleeding if the number of times of re-checking is less than the preset number,
wherein the air bleeding performing unit is further configured to:
end the checking the re-performance result value if it is determined that air is not present, and perform the air bleeding if it is determined that air is present.

20. A vehicle comprising the apparatus of claim 11.
